(19) United States
(12) Patent Application Publication
(10) Pub. No.: US 2025/0284781 A1
(43) Pub. Date: Sep. 11, 2025

(54) ELECTRONIC DEVICE AND CONTROL METHOD THEREFOR

(71) Applicant: SAMSUNG ELECTRONICS CO., LTD., Suwon-si (KR)

(72) Inventors: Seongil HAHM, Suwon-si (KR); Jinhwan KIM, Suwon-si (KR); Hyunsoo KIM, Suwon-si (KR); Moohyun SHIN, Suwon-si (KR)

(73) Assignee: SAMSUNG ELECTRONICS CO., LTD., Suwon-si (KR)

(21) Appl. No.: 19/214,754

(22) Filed: May 21, 2025

Related U.S. Application Data
(63) Continuation of application No. PCT/KR2023/018957, filed on Nov. 23, 2023.

(30) Foreign Application Priority Data
Jan. 2, 2023 (KR) 10-2023-0000237
Mar. 20, 2023 (KR) 10-2023-0035910

(51) Int. Cl. G06F 21/31; G06F 3/048

(52) U.S. Cl. CPC G06F 21/31; G06F 3/048

(57) ABSTRACT

An electronic device and a control method therefor. The electronic device includes a communication interface, a display, a user interface, a memory, and at least one processor. The at least one processor: obtains, based on a signal received via a communication interface, provisional registration information about a first external apparatus provisionally registered to a server; controls the display to output a GUI for the final authentication of a user access right to the first external apparatus; based on a user input through the output GUI, performs the final authentication of the user access right to the first external apparatus; and transmits final authentication information about the first external apparatus and user account information corresponding to the user access right to the server. The provisional registration information is identified by a second external apparatus based on the signal received, and is transmitted to the server by the second external apparatus.

### CROSS-REFERENCE TO RELATED APPLICATION

This application is a continuation application is a continuation application, under 35 U.S.C. § 111(a), of international application No. PCT/KR2023/018957, filed Nov. 23, 2023, which claims priority under 35 U. S. C. § 119 to Korean Patent Application No. 10-2023-0000237, filed Jan. 2, 2023 and Korean Patent Application No. 10-2023-0035910, filed Mar. 20, 2023, the disclosures of which are incorporated herein by reference in their entireties.

### TECHNICAL FIELD

The disclosure relates to an electronic device and a control method therefor, and more particularly, to an electronic device for improving usability and security of registration of an Internet of Things (IoT) device to a server, and a control method therefor.

### BACKGROUND ART

Internet of Things (IoT) technologies, smart devices, etc. for improving convenience and efficiency by integrally managing a plurality of devices used in a user environment, e.g., a TV, a refrigerator, a washing machine, a dryer, a microwave oven, an air conditioner, and a computer have been devised.

By connecting a plurality of devices of a user to a server, e.g., a smart device server and bringing them on board, and then granting control authority for the plurality of devices connected to the server through a user terminal device such as a smartphone, etc., the plurality of devices can be managed quickly and conveniently.

After the plurality of devices are connected to the server based on a wireless signal such as an inaudible frequency, BT/BLE, infrared rays, Wi-Fi, etc. and brought on board, the user may transmit/receive information on the plurality of devices brought on board and user account information through the user terminal device, and can thereby perform a control operation of the plurality of devices according to user access authority.

### DISCLOSURE

### Technical Solution

An electronic device according to an embodiment of the disclosure includes a communication interface, a display, a user interface, a memory to store at least one instruction; and at least one processor configured to execute the at least one instruction. The at least one processor may be configured to obtain temporary registration information of a first external device temporarily registered to a server based on a signal received through the communication interface, control the display to output a graphical user interface (GUI) for final authentication of user access authority for the first external device based on the obtained temporary registration information, and based on receiving a user input corresponding to the output GUI, finally authenticate the user access authority for the first external device based on the user input, and transmit final authentication information of the first external device and user account information corresponding to the user access authority to the server through the communication interface, wherein the temporary registration information may be identified by a second external device based on the signal received through the communication interface, and transmitted to the server by the second external device.

Meanwhile, the at least one processor may obtain the temporary registration information of the first external device registered to the server based on at least one of a first signal received from the server through the communication interface or a second signal received from the first external device through the communication interface.

Meanwhile, the at least one processor may identify whether temporary account information of the first external device obtained based on the signal received through the communication interface matches the user account information of the electronic device, and based on the temporary account information matching the user account information, obtain the temporary registration information of the first external device based on the received signal, and the temporary account information may be associated with an account identified by the second external device or an account interlocked with an account identified by the second external device.

Meanwhile, the at least one processor may identify whether the first external device is associated with a user of the electronic device based on the obtained temporary registration information of the first external device, and based on the first external device being unassociated with the user of the electronic device, control the display to output a GUI for re-registration of the device of the user of the electronic device.

Meanwhile, the at least one processor may, based on the temporary account information not matching the user account information, identify whether the first external device is associated with the user of the electronic device, and based on the first external device being associated with the user of the electronic device, output a GUI for re-registration of the first external device.

Meanwhile, the at least one processor may identify information on an access point (AP) communicatively connected with the first external device based on the temporary registration information received through the communication interface, and based on receiving an AP signal corresponding to the identified AP information, identify whether the first external device is located in the same space as the electronic device based on the received temporary registration information, and based on the first external device being located in a space in which the electronic device is located, control the display to output a GUI for final authentication of the user access authority for the first external device.

Meanwhile, the at least one processor may, based on receiving the user input through the output GUI through the user interface, transmit, to the server, a signal releasing the temporary registration of the first external device to the server through the communication interface based on the user input.

Meanwhile, the at least one processor may, based on receiving the user input through the output GUI through the user interface, identify whether the user access authority for the first external device was finally authenticated based on the received user input, identify the number of times that the user access authority for the first external device is not finally authenticated based on the received user input, and based on the number of times being greater than or equal to a predetermined value, transmit, to the server, a signal releasing the temporary registration of the first external device to the server through the communication interface.

Meanwhile, the user account may be an account interlocked with the temporary account or the user account.

A method for controlling an electronic device according to an embodiment of the disclosure includes obtaining temporary registration information of a first external device temporarily registered to a server based on a received signal, outputting a GUI for final authentication of user access authority for the first external device based on the obtained temporary registration information, and based on receiving a user input through the output GUI, finally authenticating the user access authority for the first external device based on the user input, and transmitting the final authentication information of the first external device and user account information corresponding to the user access authority to the server, wherein the temporary registration information may be identified by a second external device based on the signal received, and transmitted to the server by the second external device.

Meanwhile, in the obtaining the temporary registration information, the temporary registration information of the first external device registered to the server may be obtained based on at least one of a second signal received from the server or a third signal received from the first external device.

Meanwhile, the obtaining the temporary registration information may include identifying whether temporary account information of the first external device obtained based on the received signal matches the user account information of the electronic device, and based on the temporary account information matching the user account information, obtaining the temporary registration information of the first external device based on the received signal, and the temporary account information may be an account identified by the second external device or an account interlocked with an account identified by the second external device.

Meanwhile, the obtaining the temporary registration information may include identifying whether the first external device is associated with a user of the electronic device based on the obtained temporary registration information of the first external device, and in the outputting the GUI, based on the first external device being unassociated with the user of the electronic device, a GUI for re-registration of the device of the user of the electronic device may be output.

Meanwhile, the obtaining the temporary registration information may include, based on the temporary account information not matching the user account information, identifying whether the first external device associated with the user of the electronic device, and in the outputting the GUI, based on the first external device being associated with the user of the electronic device, a GUI for re-registration of the first external device may be output.

Meanwhile, the outputting the GUI may include identifying information on an access point (AP) communicatively connected with the first external device based on the received temporary registration information, and based on receiving an AP signal corresponding to the identified AP information, identifying whether the first external device is located in a space in which the electronic device is located based on the received temporary registration information, and based on the first external device being located in the space in which the electronic device is located, outputting a GUI for final authentication of the user access authority for the first external device.

Meanwhile, in the finally authenticating, based on receiving the user input corresponding to the output GUI, a signal releasing the temporary registration of the first external device to the server may be transmitted to the server based on the user input.

Meanwhile, the finally authenticating may include, based on receiving the user input corresponding to the output GUI, identifying whether the user access authority for the first external device was finally authenticated based on the received user input, identifying the number of times that the user access authority for the first external device is not finally authenticated based on the received user input, and based on the number of times being greater than or equal to a predetermined value, transmitting, to the server, a signal releasing the temporary registration of the first external device to the server.

Meanwhile, the user account may be an account interlocked with the temporary account or the user account.

In a non-transitory computer-readable recording medium storing computer instructions, which, when executed by a processor of an electronic device, cause the electronic device to perform operations, the operations include obtaining temporary registration information of a first external device temporarily registered to a server based on a received signal, outputting a GUI for final authentication of user access authority for the first external device based on the obtained temporary registration information, and based on receiving a user input through the output GUI, finally authenticating the user access authority for the first external device based on the user input, and transmitting the final authentication information of the first external device and user account information corresponding to the user access authority to the server, wherein the temporary registration information may be identified by a second external device based on the signal received, and transmitted to the server by the second external device.

In a system including a first external device, a second external device, a server, and an electronic device, the system may include the first external device configured to transmit a signal for temporary registration to the server to the second external device, the second external device configured to identify temporary registration information corresponding to the first external device based on the first signal received from the first external device, and transmit the identified temporary registration information to the server, the server configured to temporarily register the first external device based on the temporary registration information received from the second external device, and the electronic device configured to obtain temporary registration information of the first external device temporarily registered to the server based on a signal received through a communication interface, control the display to output a GUI for final authentication of user access authority for the first external device based on the obtained temporary registration information, and based on receiving a user input through the output GUI through a user interface, finally authenticate the user access authority for the first external device based on the user input, and transmit the final authentication information of the first external device and user account information corresponding to the user access authority to the server through the communication interface.

### DESCRIPTION OF DRAWINGS

Aspects, characteristics, and advantages of specific embodiments of the disclosure will become clearer through the following description with reference to the accompanying drawings.

FIG. 1 is a diagram for illustrating an electronic device, a first external device, a second external device, an access point (AP), and a server according to an embodiment of the disclosure;

FIG. 2 is a block diagram for illustrating a configuration of an electronic device according to an embodiment of the disclosure;

FIG. 3 is a sequence diagram for illustrating an electronic device, a first external device, a second external device, and a server according to an embodiment of the disclosure;

FIG. 4 is a flow chart for illustrating an operation of outputting a GUI for final authentication of user access authority for a first external device of an electronic device according to an embodiment of the disclosure;

FIG. 5 is a diagram for illustrating a temporary account for temporary registration to a server of a first external device or an account interlocked with the temporary account according to an embodiment of the disclosure;

FIG. 6 is a diagram for illustrating an operation of outputting a GUI for final authentication of user access authority for a first external device of an electronic device according to an embodiment of the disclosure;

FIG. 7 is a diagram for illustrating an operation of an electronic device of finally authenticating user access authority for a first external device when an electronic device is located in the same place as the first external device and an AP according to an embodiment of the disclosure;

FIG. 8 is a flow chart for illustrating an operation of an electronic device of finally authenticating user access authority for a first external device by receiving a user input according to an embodiment of the disclosure;

FIG. 9 is a diagram for illustrating an operation of finally authenticating user access authority for a first external device through a user account of an electronic device or an account interlocked with a user according to an embodiment of the disclosure; and

FIG. 10 is a flow chart for illustrating an operation of an electronic device according to an embodiment of the disclosure.

### MODE FOR INVENTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, the terms used in the disclosure are used only to explain specific embodiments, and are not intended to limit the scope of the disclosure. Also, singular expressions include plural expressions, unless defined obviously differently in the context.

Also, in the disclosure, expressions such as “have,” “may have,” “include,” and “may include” denote the existence of such characteristics (e.g.: elements such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, according to an embodiment, ‘a module’ or ‘a unit’ may perform at least one function or operation, and may be implemented as hardware or software, or as a combination of hardware and software. In addition, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, embodiments according to the disclosure will be described in detail with reference to the accompanying drawings, such that those having ordinary skill in the art to which the disclosure belongs can easily carry out the disclosure.

According to a conventional technology, by connecting a plurality of devices of a user to a server, e.g., a smart device server and bringing them on board, and then granting control authority for the plurality of devices connected to the server through a user terminal device such as a smartphone, etc., the plurality of devices can be managed quickly and conveniently.

After the plurality of devices are connected to the server based on a wireless signal such as an inaudible frequency, BT/BLE, infrared rays, Wi-Fi, etc. and brought on board, the user may transmit/receive information on the plurality of devices brought on board and user account information through the user terminal device, and can thereby perform a control operation of the plurality of devices according to user access authority.

In such a process of connecting a plurality of devices to a server and bringing them on board based on a wireless signal, a problem in signal processing caused from data transmission/reception, a problem in time consumption according to signal processing, etc. may occur, and depending on cases, a security problem of a user account may occur.

Specifically, a problem in reflection of a wireless signal, or a problem in a route of a wireless signal according to diffraction may occur. As a wireless signal is interfered by a still object such as a wall or a structure, or a moving object such as a person, an animal, etc., the route may be changed, and as the distance from the source of the signal becomes farther, the strength of the wireless signal becomes weaker, and thus a problem that it is difficult to receive the wireless signal at a reception device may occur. Also, as a wireless signal is transmitted to another space, a security problem such as leakage of information like a user account, a password, etc., or wrong connection of a user device to a user account of a third party may occur.

Accordingly, there is a request for search of a method by which, after a plurality of devices are registered to a server in advance before a user controls the plurality of devices, and on a time point when the user actually controls the devices, the user can perform control of the devices only if the user performs simple final authentication of user access authority for the devices without a separate device registration process, and a method by which a user's devices can be used through the user's account without a security problem of the user's account.

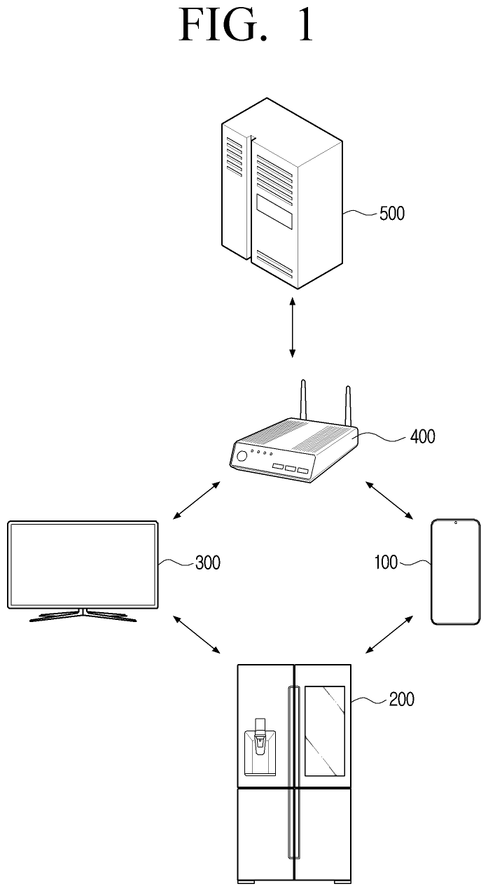

FIG. 1 is a diagram for illustrating an electronic device, a first external device, a second external device 300, an access point (AP), and a server according to an embodiment of the disclosure.

Referring to FIG. 1, the first external device 200 may transmit a first signal for temporary registration to a server 500 to the second external device 300. The second external device 300 may identify temporary registration information corresponding to the first external device 200 based on the first signal received from the first external device 200, and transmit the identified temporary registration information to the server 500. The server 500 may temporarily register the first external device 200 to the server 500 based on the temporary registration information received from the second external device 300.

Temporary registration may mean a state wherein the first external device 200 was connected to the server 500 and was registered through a temporary account based on a wireless signal. Here, the wireless signal may be a wireless signal such as an inaudible frequency, BT/BLE, infrared rays, Wi-Fi, etc., but is not limited thereto, and it may be signals in various forms that can transmit/receive data between devices.

In a state wherein the first external device 200 was temporarily registered to the server 500, the user of the temporarily registered account may not have control authority for the first external device 200, and use information of the first external device 200 such as the use history of the first external device 200, the history, etc. may not be transmitted to the server 500. That is, while the first external device 200 was registered to the server 500, the user does not have user access authority through a user terminal device, etc., and thus it may be a lock state wherein the first external device 200 cannot be used.

The temporary registration information may be information of the first external device 200 (e.g.: the product name, the model information, the code, the smart function, etc.), temporary account information for temporarily registering the first external device 200 to the server 500, and information on a specific space inside a house wherein the first external device 200 is located, but is not limited thereto, and it may include general information for the first external device 200.

Here, the first external device 200 and the second external device 300 may be home appliances such as a refrigerator, an air conditioner, a microwave oven, a cleaner, a TV, a computer, a washing machine, a dryer, etc., but are not limited thereto. Other than the above, the first external device 200 and the second external device 300 may be implemented as user terminal devices such as a smartphone, a tablet PC, a wearable device, etc.

Also, the first external device 200 and the second external device 300 be constituted as one device but not different devices. Specifically, the one device may transmit, to the server 500, a signal including temporary registration information for temporary registration to the server 500.

Other than the above, the roles of the first external device 200 and the second external device 300 may be changed with each other, unlike what was described above. Specifically, the second external device 300 may transmit a signal for temporary registration to the server 500 to the first external device 200. The first external device 200 may identify temporary registration information corresponding to the second external device 300 based on the signal received from the second external device 300, and transmit the identified temporary registration information to the server 500. The server 500 may temporarily register the second external device 300 to the server 500 based on the temporary registration information received from the first external device 200.

The aforementioned temporary registration process of the first external device 200 to the server 500 may be performed automatically as a background state without the user's intervention. The process of temporarily registering the first external device 200 to the server 500 is for involving a process of transmission/reception of data such as temporary registration information and making the temporary registration completed in advance without the user's intervention. Also, as the first external device 200 is registered to the server 500 through the second external device 300, even when communicative connection of the first external device 200 to the AP 400 is rather difficult, a temporary registration process can be performed smoothly.

The electronic device 100 may be, for example, a user terminal device such as a smartphone, a tablet PC, a wearable device, etc., but is not limited thereto. Other than the above, the electronic device 100 may be a home appliance, e.g., a washing machine, an air conditioner, a TV, a dryer, a refrigerator, and a water purifier. However, the home appliance mentioned here is not limited thereto, and it may be various electronic devices used in assisting with the user's life or job.

Also, the electronic device 100 may be a single device integrated with at least one of the first external device 200 or the second external device 300. Specifically, the electronic device 100 may be the first external device 200 or the second external device 300, or it may be one device wherein the electronic device 100 is integrated with the first external device 200 and the second external device 300.

The electronic device 100 may obtain temporary registration information of the first external device 200 temporarily registered to the server 500 based on a signal received through the communication interface 110. The electronic device 100 may control the display 120 to output a GUI for final authentication of user access authority for the first external device 200 based on the obtained temporary registration information. If a user input corresponding to the output GUI is received through the user interface 130, the electronic device 100 may finally authenticate user access authority for the first external device 200 based on the user input.

Other than the above, if a user input for final authentication is received, the electronic device 100 may transmit a signal corresponding to the user input for final authentication to the server 500 through the communication interface 110, and the server 500 may finally authenticate user access authority based on the received signal.

The final authentication method may be various authentication methods such as QR authentication, password input authentication, button authentication, etc. The electronic device 100 may transmit final authentication information of the first external device 200 and user account information corresponding to user access authority to the server 500 through the communication interface 110.

Also, as described above, the first external device 200 and the second external device 300 may be one device but not different devices. Specifically, the electronic device 100 may obtain temporary registration information of one device temporarily registered to the server 500. The electronic device 100 may control the display 120 to output a GUI for final authentication of user access authority for the one device based on the obtained temporary registration information. When a user input corresponding to the output GUI is received through the communication interface 130, the electronic device 100 may finally authenticate user access authority for the one device based on the user input. However, the disclosure is not limited to the aforementioned embodiment, and the electronic device 100 may be a single device integrated with at least one of the first external device 200 or the second external device 300.

As described above, the user can obtain control authority for a device swiftly and conveniently by performing only a final authentication process for obtaining user access authority for the device that was already temporarily registered through the electronic device 100.

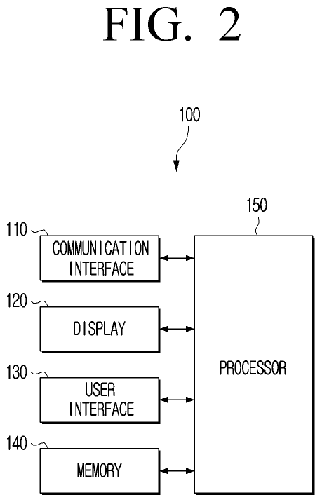

FIG. 2 is a block diagram for illustrating a configuration of the electronic device 100 according to an embodiment of the disclosure.

Referring to FIG. 2, the electronic device 100 may include a communication interface 110, a display 120, a user interface 130, memory 140, and at least one processor (referred to as the processor hereinafter).

The communication interface 110 may include a wireless communication interface, a wired communication interface, or an input interface. The wireless communication interface may perform communication with various types of external devices by using a wireless communication technology or a mobile communication technology. As such a wireless communication technology, for example, Bluetooth, Bluetooth low energy, CAN communication, Wi-Fi, Wi-Fi Direct, ultrawide band (UWB) communication, Zigbee, infrared Data Association (IrDA), or near field communication (NFC), etc. may be included, and as a mobile communication technology, 3GPP, Wi-Max, long term evolution (LTE), 5G, etc. may be included.

The wireless communication interface may be implemented by using an antenna that can transmit electromagnetic waves to the outside or receive electromagnetic waves transmitted from the outside, a communication chip, and a substrate, etc.

Any one of the wireless communication interface or the wired communication interface may be omitted depending on embodiments. Accordingly, the electronic device 100 may include only the wireless communication interface or the wired communication interface. Not only that, the electronic device 100 may include an integrated communication interface that supports both wireless connection by the wireless communication interface and wired connection by the wired communication interface.

The electronic device 100 is not limited to a case of including one communication interface 110 performing communicative connection by one method, but may include a plurality of communication interfaces 110 performing communicative connection by a plurality of methods.

The processor may perform communicative connection with devices such as the first external device 200, the second external device 300, the AP 400, the server 500, etc. through the communication interfaces 110.

The processor may perform communicative connection with the AP 400, the server 500, the first external device 200, and the second external device 300 through the communication interfaces 110, and obtain temporary registration information corresponding to the first external device 200, and information on the AP 400, the server 500, and the first external device 200 based on a received signal.

The processor may perform communicative connection with the AP 400, the server 500, etc. through the communication interfaces 110, and transmit final authentication information of user access authority, user account information, information on an account interlocked with the user account, etc.

The information transmitted/received by the processor and the devices for which the processor performs communicative connection through the communication interfaces 110 are not limited to what is described above, and they may include various types of information and devices.

The display 120 may include various types of display panels such as a liquid crystal display (LCD) panel, an organic light emitting diodes (OLED) panel, an active-matrix organic light-emitting diode (AM-OLED), liquid crystal on silicon (LcoS), quantum dot light-emitting diode (QLED), digital light processing (DLP), a plasma display panel (PDP), an inorganic LED panel, a micro LED panel, etc., but is not limited thereto. Meanwhile, the display 120 may constitute a touch screen together with a touch panel, and may also be a flexible panel.

The display 120 may be implemented as a square or a rectangle in a 2D shape, but is not limited thereto, and it may be implemented in various shapes such as a circle, a polygon, a 3D stereoscopic form, etc.

The processor may control the display 120 to output a GUI for final authentication of user access authority for the first external device 200.

Specifically, the processor may control the display 120 to output temporary registration information of the first external device 200, temporary account information, confirmation information for final authentication of user access authority, user account information, and a GUI for inputting a password of a user account.

The GUI may be a figure or a text in a still state or a figure or a text in a moving state. Also, the processor may control the display 120 to output a GUI involving various animation effects.

The user interface 130 may include an interface of a button type, a lever type, a switch type, a touch type, etc., and the touch type interface may be implemented in a method of receiving an input by a user's touch on the display 120.

The processor may receive a user input through the user interface 130. If a user input corresponding to a GUI output through the display 120 is received through the user interface 130, the processor may perform an operation corresponding to the received user input.

Specifically, the processor may receive an input for final authentication of user access authority of the first external device 200 (e.g.: an input of account information or a password), an input releasing temporary registration of the first external device 200 temporarily registered to the server 500, an input for final authentication of user access authority for the first external device 200 temporarily registered to the server 500 through another account interlocked with the user account, etc. through the user interface 130. Meanwhile, a user input received by the processor through the user interface 130 is not limited thereto.

The memory 140 stores various types of programs or data temporarily or non-temporarily, and transmits the stored information to the processor according to a call by the processor. Also, the memory 140 may store various types of information necessary for an operation, and a processing or control operation, etc. of the processor in electronic formats.

The memory 140 may include, for example, at least one of a main memory device or an auxiliary memory device. The main memory device may be implemented by using a semiconductor storage medium such as ROM and/or RAM. ROM may include, for example, ROM, EPROM, EEPROM, and/or MASK-ROM, etc. which are general. RAM may include, for example, DRAM and/or SRAM, etc. The auxiliary memory device may be implemented by using at least one storage medium that can store data permanently or semi-permanently like an optical medium such as a flash memory device, a secure digital (SD) card, a solid state drive (SSD), a hard disc drive (HDD), a magnetic drum, a compact disc, a DVD, or a laser disc, etc., a magnetic tape, a magneto-optical disc, and/or a floppy disc, etc.

The memory 140 may store information on the first external device 200, information on the second external device 300, information on the AP 400, and information on the server 500. Specifically, the memory 140 may store signal information for performing communicative connection with each device, a communication protocol, IP address information, and device code information, etc., but is not limited thereto, and the memory 140 may store various types of information necessary for performing communicative connection with each device.

The memory 140 may store temporary registration information of the first external device 200, information on a temporary account used for temporary registration, and information on an account interlocked with the temporary account.

The memory 140 may store final authentication information of user access authority for the first external device 200, information on a user account, and information on an account interlocked with the user account.

The processor 150 controls the overall operations of the electronic device 100. Specifically, the processor 150 may be connected with the components of the electronic device 100 including the memory 140 as described above, and control the overall operations of the electronic device 100 by executing the at least one instruction stored in the memory 140 as described above. In particular, the processor 150 may not only be implemented as one processor 150, but also be implemented as a plurality of processors 150.

The at least one processor 150 may be implemented by various methods. For example, the at least one processor 150 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 150 may control one or a random combination of the other components of the electronic device 100, and perform an operation related to communication or data processing. Also, the at least one processor 150 may execute one or more programs or instructions stored in the memory 140. For example, the at least one processor 150 may perform the method according to an embodiment of the disclosure by executing the one or more instructions stored in the memory 140.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 150 may be implemented as a single core processor including one core, or may be implemented as one or more multicore processors including a plurality of cores (e.g., multicores of the same kind or multicores of different kinds). In case the at least one processor is implemented as multicore processors, each of the plurality of cores included in the multicore processors may include internal memory of the processor such as on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor 150 may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

The processor 150 may obtain temporary registration information of the first external device 200 temporarily registered to the server 500 based on a signal received through the communication interface 110. Here, the processor 150 may perform communicative connection with the first external device 200 or the server 500 through the communication interface 110, and obtain temporary registration information of the first external device 200. Also, the temporary registration information may include information of the first external device 200 (e.g.: the product name, the product information, information on the smart function, etc.), information on a temporary account used for temporarily registering the first external device 200 to the server 500, or information on another account interlocked with the temporary account.

The processor 150 may control the display 120 to output a GUI for final authentication of user access authority for the first external device 200 based on the obtained temporary registration information.

When a user input corresponding to the output GUI is received through the user interface 130, the processor 150 may finally authenticate user access authority for the first external device 200 based on the user input. The final authentication method may be various authentication methods such as QR authentication, password input authentication, button authentication, etc.

The processor 150 may transmit the final authentication information of the first external device 200 and user account information corresponding to the user access authority to the server 500 through the communication interface 110. The processor 150 may transmit information on another account interlocked with the user account, e.g., information on a family account other than the user account information to the server 500 through the communication interface 110.

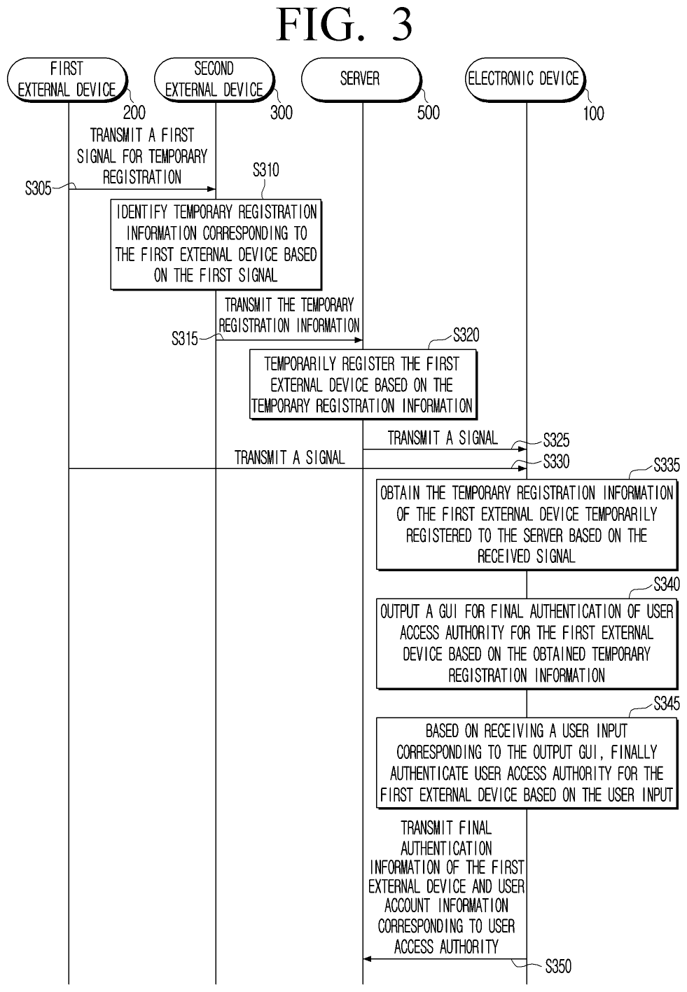

A detailed method for controlling the electronic device 100 by the processor according to the disclosure, and a final authentication method of user access authority of the first external device 200 according to communicative connection with the first external device 200, the second external device 300, the AP 400, and the server 500 will be described in more detail with reference to FIG. 3 to FIG. 9.

FIG. 3 is a sequence diagram for illustrating an electronic device, the first external device 200, the second external device 300, and the server 500 according to an embodiment of the disclosure.

Referring to FIG. 3, the first external device 200 may perform communicative connection with the second external device 300, and transmit a first signal for temporary registration to the second external device 300 in the operation S305.

Here, the first signal for temporary registration may include information of the first external device 200 (e.g.: the product name, the model information, the smart function, etc.).

The second external device 300 may identify temporary registration information corresponding to the first external device 200 based on the first signal received from the first external device 200 through the communication interface 110 in the operation S310.

Here, the temporary registration information may include information on a temporary account used for temporarily registering the first external device 200 to the server 500. The second external device 300 may generate a temporary account based on the received first signal, or allot a temporary account stored in advance in the second external device 300 to the first external device 200. Also, the second external device 300 may identify another account interlocked with the temporary account (e.g.: a family account interlocked with the temporary account, etc.) as the temporary account, and use it for temporary registration of the first external device 200 to the server 500.

However, the disclosure is not limited thereto, and the second external device 300 may perform communicative connection with the external server 500 and an external device, and receive information on a temporary account that will be used in temporarily registering the first external device 200 to the server 500.

Also, the second external device 300 may designate the current space wherein the first external device 200 is located (e.g.: a living room, a kitchen, a master bedroom, a toilet, etc.) based on the received information of the first external device 200 and information on the strength of a signal received from the first external device 200, and include the information in the temporary registration information and store it.

The second external device 300 may perform communicative connection with the server 500, and transmit the temporary registration information to the server 500 in the operation S315.

The server 500 may temporarily register the first external device 200 to the server 500 based on the received temporary registration information in the operation S320.

The aforementioned communicative connection between the first external device 200 and the second external device 300 (and the server 500), transmission/reception of signals, transmission/reception of temporary registration information, and a temporary registration process of the first external device 200 to the server 500 may be performed through signal relay between the server 500 of the AP 400 and the second external device 300 in a background state without the user's intervention, and may be implemented by a device authentication method based on a general wireless signal (e.g.: IR, Wi-Fi, BT/BLE, and an inaudible frequency such as ultrasonic waves, etc.).

The electronic device 100 may perform communicative connection with at least one of the server 500 or the first external device 200 through the communication interface 110, and receive a signal in the operations S325 and S330. Here, the signal received by the electronic device 100 may include temporary registration information of the first external device 200 to the server 500.

The electronic device 100 may obtain the temporary registration information of the first external device 200 temporarily registered to the server 500 based on the received signal in the operation S335.

The electronic device 100 may control the display 120 to output a GUI for final authentication of user access authority for the first external device 200 based on the obtained temporary registration information in the operation S340.

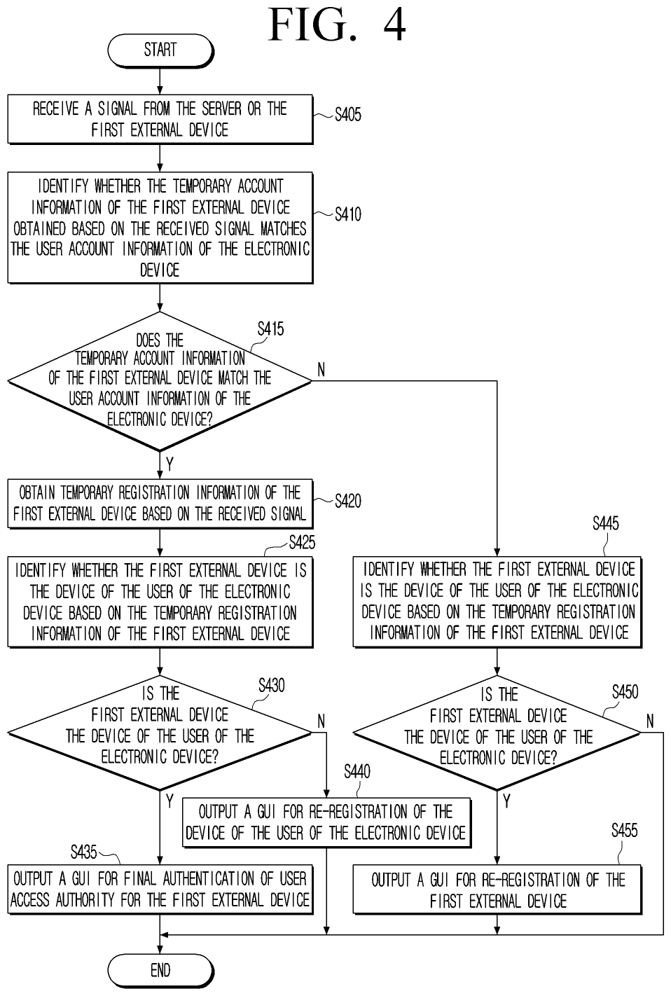

FIG. 4 is a flow chart for illustrating an operation of outputting a GUI for final authentication of user access authority for the first external device 200 of the electronic device 100 according to an embodiment of the disclosure.

Referring to FIG. 4, the electronic device 100 may receive a signal from the server 500 or the first external device 200 through the communication interface 110 in the operation S405.

The electronic device 100 may identify whether the temporary account information of the first external device 200 obtained based on the received signal matches the user account information of the electronic device 100 in the operation S410. Here, the temporary account may be an account identified by the second external device 300 or an account interlocked with an account identified by the second external device 300, e.g., a temporary family account.

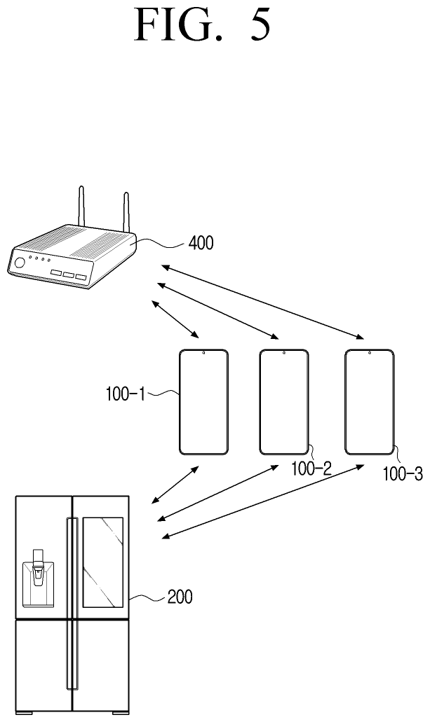

FIG. 5 is a diagram for illustrating a temporary account for temporary registration to the server 500 of the first external device 200 or an account interlocked with the temporary account according to an embodiment of the disclosure.

Referring to FIG. 5, a temporary account of the user of the electronic device 100 may be a temporary account corresponding to the electronic device 100-1 of the user, and a temporary account interlocked with the temporary account of the user may be a temporary account corresponding to other electronic devices 100-2, 100-3 connected to the temporary account of the user as a family account.

Accordingly, the server 500 or the first external device 200 may perform communicative connection with the electronic device 100-1 of the user through the communication interface 110, and transmit the information on the temporary account interlocked with the temporary account of the user to the electronic device 100-1.

The user of the electronic device 100-1 may receive information on the account used for temporary registration of the first external device 200 among the accounts interlocked with the user's temporary account.

If the temporary account information of the first external device 200 matches the user account information of the electronic device 100 in the operation S415-Y, the electronic device 100 may obtain temporary registration information of the first external device 200 based on the received signal in the operation S420.

The electronic device 100 may identify whether the first external device 200 is the device of the user of the electronic device 100 based on the temporary registration information of the first external device 200 in the operation S425.

In case the first external device 200 is the device of the user of the electronic device 100 in the operation S430-Y, the electronic device 100 may control the display 120 to output a GUI for final authentication of user access authority for the first external device 200 in the operation S435.

In case the first external device 200 is not the device of the user of the electronic device 100 in the operation S430-N, the electronic device 100 may output a GUI for re-registration of the device of the user of the electronic device 100 in the operation S440. That is, it is a process for re-registering the device of the user of the electronic device 100 in case a device of another third party was temporarily registered through the temporary account of the user of the electronic device 100.

If the temporary account information of the first external device 200 does not match the user account information of the electronic device 100 in the operation S415-N, the electronic device 100 may identify whether the first external device 200 is the device of the user of the electronic device 100 based on the temporary registration information of the first external device 200 in the operation S445.

If the first external device 200 is identified as the device of the user of the electronic device 100 in the operation S450-Y, the electronic device 100 may control the display 120 to output a GUI for re-registration of the first external device 200. That is, it is a process for re-registering the device through the temporary account of the user of the electronic device 100 in case the device of the user of the electronic device 100 was temporarily registered to the server 500 through an account of another third party.

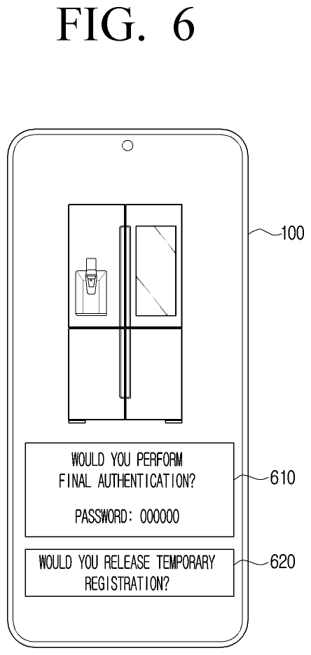

FIG. 6 is a diagram for illustrating an operation of outputting a GUI for final authentication of user access authority for the first external device 200 of the electronic device 100 according to an embodiment of the disclosure.

Referring to FIG. 6, the electronic device 100 may control the display 120 to output a GUI 610 for final authentication of user access authority for the first external device 200 together with an image corresponding to the first external device 200. Here, the GUI 610 for final authentication may include a text regarding a query asking about whether the user would finally authenticate such as “Would you perform final authentication?” or a password input field, but the disclosure is not limited thereto, and the GUI 610 may be provided in different forms.

The electronic device 100 may control the display 120 to output a GUI corresponding to various final authentication methods such as QR authentication, button authentication, etc.

Other than the above, the electronic device 100 may control the display 120 to output a GUI 620 for release of temporary registration of the first external device 200 temporarily registered to the server 500. In case the device of the user was temporarily registered to the server 500 through a temporary account of a third party, or a device of a third party was temporarily registered to the server 500 through the temporary account of the user as described above, the electronic device 100 may control the display 120 to output a GUI (not shown) for re-registering the device of the user through the temporary account of the user.

Also, in case the electronic device 100 is located in the same space as the first external device 200 temporarily registered to the server 500, the electronic device 100 may control the display 120 to output a GUI 620 for final authentication of user access authority for the first external device 200.

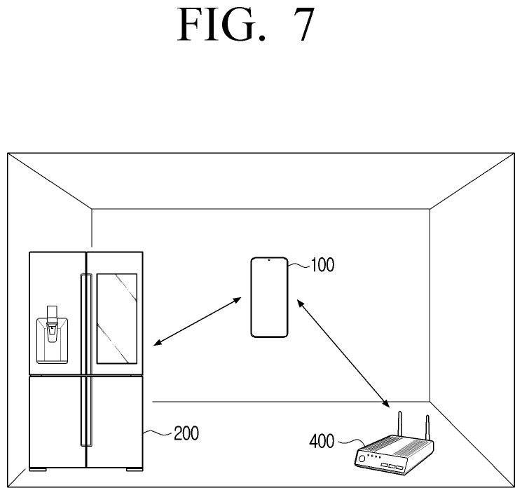

FIG. 7 is a diagram for illustrating an operation of the electronic device 100 of finally authenticating user access authority for the first external device 200 when the electronic device 100 is located in the same place as the first external device 200 and the AP 400 according to an embodiment of the disclosure.

Referring to FIG. 7, the electronic device 100 may identify information on the access point (AP) 400 communicatively connected to the first external device 200 based on temporary registration information received through the communication interface 110.

The electronic device 100 may identify whether the first external device 200 and the electronic device 100 are located in the same space, e.g., a living room, a master bedroom, etc. based on the identified information.

Specifically, the electronic device 100 may identify whether the first external device 200 and the electronic device 100 are located within the same space based on information on the AP 400 performing communicative connection with the first external device 200, the strength of a signal received from the first external device 200, and the strength of a signal received from the AP 400.

In case the first external device 200 and the electronic device 100 are located in the same space, the electronic device 100 may control the display 120 to output a GUI 610 for final authentication of user access authority for the first external device 200 based on the received temporary registration information.

When a user input corresponding to the output GUI is received, the electronic device 100 may perform an operation of finally authenticating user access authority for the first external device 200 based on the user input in the operation S345. A method of performing an operation of finally authenticating user access authority may be performed by QR authentication, button authentication, etc., but is not limited thereto.

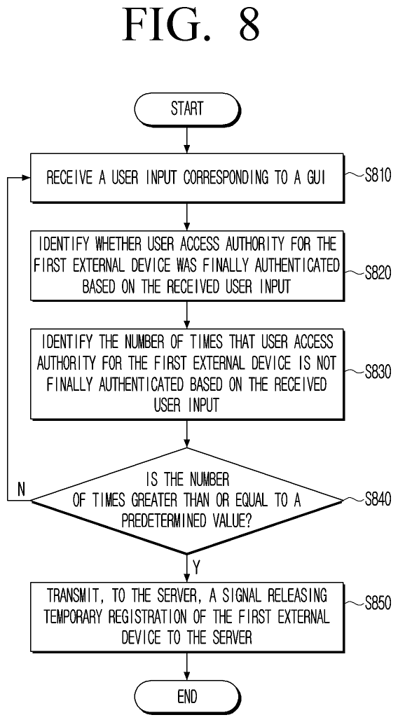

FIG. 8 is a flow chart for illustrating an operation of the electronic device 100 of finally authenticating user access authority for the first external device 200 by receiving a user input according to an embodiment of the disclosure.

Referring to FIG. 8, the electronic device 100 may receive a user input corresponding to a GUI through the user interface 130 in the operation S810.

The electronic device 100 may identify whether user access authority for the first external device 200 was finally authenticated based on the received user input in the operation S820.

The electronic device 100 may identify the number of times that user access authority for the first external device 200 is not finally authenticated based on the received user input in the operation S830.

If the number of times that user access authority is not finally authenticated is greater than or equal to a predetermined value in the operation S840-Y, the electronic device 100 may perform communicative connection with the server 500 through the communication interface 110, and transmit, to the server 500, a signal releasing temporary registration of the first external device 200 to the server 500 in the operation S850.

If the number of times that user access authority is not finally authenticated is smaller than the predetermined value in the operation S840-N, the electronic device 100 may additionally receive a user input corresponding to the GUI through the user interface 130 in the operation S810.

If a user input corresponding to the output GUI wherein final authentication of user access authority is possible is received through the user interface 130, the electronic device 100 may perform communicative connection with the server 500 through the communication interface 110, and transmit final authentication information of the first external device 200 and user account information corresponding to user access authority to the server 500 in the operation S350.

Here, the electronic device 100 may perform communicative connection with the server 500 through the communication interface 110, and grant user access authority for the first external device 200 to an account interlocked with the user account but not the user account, e.g., a family account.

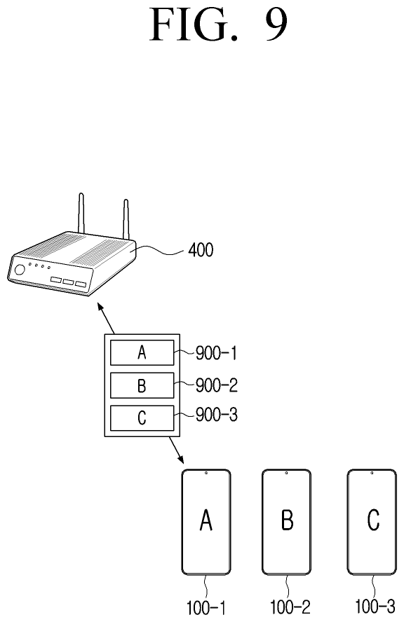

FIG. 9 is a diagram for illustrating an operation of finally authenticating user access authority for the first external device 200 through a user account of the electronic device 100 or an account interlocked with a user according to an embodiment of the disclosure.

Referring to FIG. 9, when the electronic device 100 transmits user account information corresponding to user access authority for the first external device 200 to the server 500 through the communication interface 110, the electronic device 100 may transmit together account information 900-2, 900-3 corresponding to the electronic devices 100-2, 100-3 interlocked with the user account other than user account information 900-1 corresponding to the electronic device 100-1 of the user, or transmit only account information 900-2, 900-3 corresponding to the electronic devices 100-2, 100-3 interlocked with the user account, and may thereby grant user access authority for the first external device 200 to another account interlocked with the user account.

Accordingly, control authority for the first external device 200 can be obtained not only through the user account but also a family account of the user.

By this, the electronic device 100 may obtain control authority and access authority for the first external device 200 registered to the server 500. The electronic device 100 may perform communicative connection with the server 500 through the communication interface 110, and transmit a signal for controlling the first external device 200 registered to the server 500, or receive use information, history information, and state information of the first external device 200.

Also, the electronic device 100 may perform direct communicative connection with the first external device 200 through the communication interface 110, and transmit a signal for controlling the first external device 200 registered to the server 500, or receive use information, history information, and state information of the first external device 200.

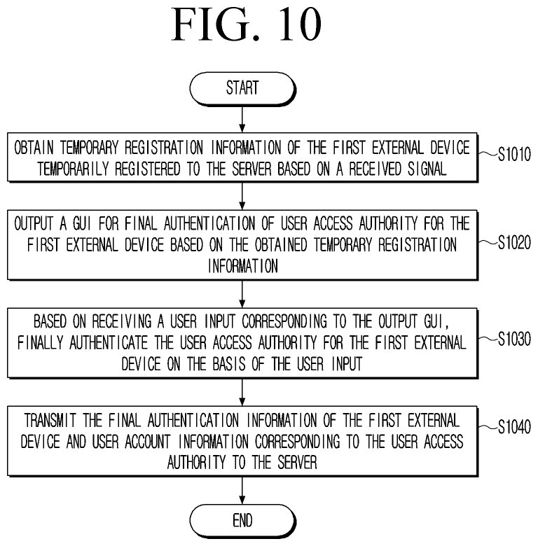

FIG. 10 is a flow chart for illustrating an operation of the electronic device 100 according to an embodiment of the disclosure.

Referring to FIG. 10, the electronic device 100 may control the display 120 to output a GUI for final authentication of user access authority for the first external device 200 based on the obtained temporary registration information.

The electronic device 100 may obtain temporary registration information of the first external device 200 temporarily registered to the server 500 based on a signal received through the communication interface 110 in the operation S1010. Here, the electronic device 100 may perform communicative connection with the first external device 200 or the server 500 through the communication interface 110, and obtain temporary registration information of the first external device 200. Also, the temporary registration information may include information of the first external device 200 (e.g.: the product name, the product information, information on the smart function, etc.), information on a temporary account used for temporarily registering the first external device 200 to the server 500, or information on another account interlocked with the temporary account.

The electronic device 100 may control the display 120 to output a GUI for final authentication of user access authority for the first external device 200 based on the obtained temporary registration information in the operation S1020.

When a user input corresponding to the output GUI is received through the user interface 130, the electronic device 100 may finally authenticate the user access authority for the first external device 200 based on the user input in the operation S1030. The final authentication method may be various authentication methods such as QR authentication, password input authentication, button authentication, etc.

The electronic device 100 may transmit the final authentication information of the first external device 200 and user account information corresponding to the user access authority to the server 500 through the communication interface 110 in the operation S1040. The electronic device 100 may transmit information on another account interlocked with the user account, e.g., information on a family account other than the user account information to the server 500 through the communication interface 110.

By this, the electronic device 100 may obtain control authority and access authority for the first external device 200 registered to the server 500. The electronic device 100 may perform communicative connection with the server 500 through the communication interface 110, and transmit a signal for controlling the first external device 200 registered to the server 500, or receive use information, history information, and state information of the first external device 200.

Also, the electronic device 100 may perform direct communicative connection with the first external device 200 through the communication interface 110, and transmit a signal for controlling the first external device 200 registered to the server 500, or receive use information, history information, and state information of the first external device 200.

The electronic device 100 may additionally include components such as a microphone, a camera, a speaker, a sensor, etc. as other components, or some components may be omitted.

The microphone may mean a module that obtains a sound and converts it into an electric signal, and it may be a condenser microphone, a ribbon microphone, a moving coil microphone, a piezoelectric element microphone, a carbon microphone, and a micro electro mechanical system (MEMS) microphone. Also, the microphone may be implemented by methods such as a non-directional method, a bi-directional method, a uni-directional method, a sub cardioid method, a super cardioid method, and a hyper cardioid method.

The microphone may detect a user voice and generate an electric signal corresponding to the user voice, and the processor 150 may obtain user voice information based on the electric signal corresponding to the user voice obtained through the microphone.

The processor 150 may identify a user voice command based on the obtained user voice information. Specifically, the processor 150 may include a speech to text (STT) module, and identify the electric signal corresponding to the user voice in a text form through the STT module. The processor 150 may perform an operation corresponding to the identified user voice command. Here, when identifying a user voice command, the processor 150 may identify a user voice command included in the electric signal corresponding to the user voice or the text corresponding to the electric signal by using a language model (LM) and an automatic sound recognition (ASR) model.

The processor 150 may obtain a user voice command for temporary registration of the first external device 200 to the server 500 or release of temporary registration, and perform an operation of temporary registration of the first external device 200 to the server 500 or release of temporary registration.

Other than the above, the processor 150 may obtain a user voice command for final authentication of user access authority for the first external device 200, and perform an operation of final authentication of user access authority for the first external device 200.

The camera may photograph still images and moving images. According to an embodiment, the camera module may include at least one lens, an image sensor, an image signal processor 150, or a flash.

The processor 150 may identify whether the first external device 200 is located in the same space as the electronic device 100 based on a still image or a moving image photographed through the camera.

In case the first external device 200 is located in the same space as the electronic device 100, the processor 150 may perform an operation of temporary registration of the first external device 200 to the server 500 or an operation of final authentication of user access authority.

The speaker may be a tweeter for reproducing sounds of high-pitched ranges, a mid-range for reproducing sounds of mid-pitched ranges, a woofer for reproducing sounds of low-pitched ranges, a sub-woofer for reproducing sounds of extreme low-pitched ranges, an enclosure for controlling resonances, and a crossover network dividing frequencies of electric signals input into the speaker by each band, etc.

The processor 150 may control the speaker to output a guide voice or a notification sound for final authentication of user access authority for the first external device 200. Also, the processor 150 may control the speaker to output a voice or a notification sound for guiding temporary registration of the first external device 200 to the server 500.

When a signal for the first external device 200 for which temporary registration to the server 500 was completed is received, the processor 150 may control the speaker to output a notification sound notifying that the first external device 200 that is temporarily registered exists.

The sensor may be a gesture sensor, or a sensor detecting a signal received from an external device. The gesture sensor may detect a motion or a gesture of a user located within a predetermined distance from a user terminal device, and the signal detection sensor may be a sensor that detects a signal received from an external device to the electronic device 100, and may include a sensor for detecting an inaudible frequency, a Wi-Fi signal detection sensor, an ultrasonic detection sensor, a Bluetooth signal detection sensor, etc. other than an IR sensor, but is not limited thereto.

The processor 150 may perform an operation corresponding to a motion or a gesture of the user based on the motion or the gesture of the user detected through the gesture sensor. Here, the operation corresponding to the motion or the gesture of the user may be an operation of temporary registration of the first external device 200 to the server 500, release of temporary registration, or final authentication of user access authority for the first external device 200, but is not limited thereto.

The processor 150 may detect a signal received from an external device, etc. through the signal detection sensor, and obtain information on temporary registration of the first external device 200 to the server 500, information on a temporary account, information on an account interlocked with the temporary account, and information on final authentication of user access authority for the first external device 200, but the information obtained based on the detected signal is not limited thereto.

According to an embodiment, the method according to the various embodiments described in the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed directly between two user devices (e.g.: smartphones), and distributed on-line (e.g.: download or upload) through an application store (e.g.: Play Store™). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. An electronic device comprising:
a communication interface;
a display;
a user interface;
a memory to store at least one instruction; and
at least one processor;
wherein the at least one instruction stored in the memory that when executed by the at least one processor individually or collectively, causes the electronic device to:
obtain temporary registration information of a first external device temporarily registered to a server,
control the display to output a graphical user interface (GUI) for final authentication of user access authority for the first external device based on the obtained temporary registration information,
based on a user input corresponding to the output GUI, finally authenticate the user access authority for the first external device, and
transmit final authentication information of the first external device and user account information corresponding to the user access authority to the server through the communication interface,
wherein the temporary registration information is identified by a second external device based on a first signal received from the first external device, and transmitted to the server by the second external device.

2. The electronic device of claim 1,
wherein the at least one instruction stored in the memory that when executed by the at least one processor individually or collectively, causes the electronic device to:
obtain the temporary registration information of the first external device registered to the server based on at least one of a second signal received from the server through the communication interface or a third signal received from the first external device through the communication interface.

3. The electronic device of claim 2,
wherein the at least one instruction stored in the memory that when executed by the at least one processor individually or collectively, causes the electronic device to:
identify whether temporary account information of the first external device obtained based on the at least one of the second signal or the third signal matches the user account information of the electronic device,
based on the temporary account information matching the user account information, obtain the temporary registration information of the first external device, and
wherein the temporary account information is associated with an account identified by the second external device or an account interlocked with an account identified by the second external device.

4. The electronic device of claim 3,
wherein the at least one instruction stored in the memory that when executed by the at least one processor individually or collectively, causes the electronic device to:
identify whether the first external device is associated with a user of the electronic device based on the obtained temporary registration information of the first external device, and
based on the first external device being unassociated with the user of the electronic device, control the display to output a GUI for re-registration of the first external device as a device of the user.

5. The electronic device of claim 3,
wherein the at least one instruction stored in the memory that when executed by the at least one processor individually or collectively, causes the electronic device to:
based on the temporary account information not matching the user account information, identify whether the first external device is associated with a user of the electronic device, and
based on the first external device being associated with the user of the electronic device, output a GUI for re-registration of the first external device as a device of the user.

6. The electronic device of claim 1,
wherein the at least one processor is configured to:
identify information on an access point (AP) communicatively connected with the first external device based on the temporary registration information,
based on receiving an AP signal corresponding to the identified AP information, identify whether the first external device is located in a space in which the electronic device is located, and
based on the first external device being located in the space in which the electronic device is located, control the display to output a GUI for final authentication of the user access authority for the first external device.

7. The electronic device of claim 1,
wherein the at least one processor is configured to:
based on receiving the user input corresponding to the output GUI, transmit, to the server, a fourth signal releasing a temporary registration of the first external device to the server through the communication interface.

8. The electronic device of claim 7,
wherein the at least one processor is configured to:
based on receiving the user input corresponding to the output GUI, identify whether the user access authority for the first external device was finally authenticated,
identify a number of times that the user access authority for the first external device is not finally authenticated based on identifying whether the user access authority for the first external device was finally authenticated, and
based on the number of times being greater than or equal to a predetermined value, transmit, to the server, the fourth signal releasing a temporary registration of the first external device to the server through the communication interface.

9. The electronic device of claim 1,
wherein the user account information is corresponding to a user account or an account interlocked with the user account.

10. A control method of an electronic device, the control method comprising:
obtaining temporary registration information of a first external device temporarily registered to a server;
outputting a graphical user interface (GUI) for final authentication of user access authority for the first external device based on the obtained temporary registration information;
based on a user input corresponding to the output GUI, finally authenticating the user access authority for the first external device; and
transmitting final authentication information of the first external device and user account information corresponding to the user access authority to the server,
wherein the temporary registration information is identified by a second external device based on a first signal received from the first external device, and transmitted to the server by the second external device.

11. The control method of claim 10,
wherein the obtaining the temporary registration information comprises:
obtaining the temporary registration information of the first external device registered to the server based on at least one of a second signal received from the server or a third signal received from the first external device.

12. The control method of claim 11,
wherein the obtaining the temporary registration information comprises:
identifying whether temporary account information of the first external device obtained based on at least one of the second signal or the third signal matches the user account information of the electronic device; and
based on the temporary account information matching the user account information, obtaining the temporary registration information of the first external device, and
wherein the temporary account information is associated with an account identified by the second external device or an account interlocked with an account identified by the second external device.

13. The control method of claim 12,
wherein the obtaining the temporary registration information comprises:
identifying whether the first external device is associated with a user of the electronic device based on the obtained temporary registration information of the first external device, and
the outputting the GUI comprises:
based on the first external device being unassociated with the user of the electronic device, outputting a GUI for re-registration of the first external device as a device of the user.

14. The control method of claim 12,
wherein the obtaining the temporary registration information comprises:
based on the temporary account information not matching the user account information, identifying whether the first external device is associated with a user of the electronic device, and
the outputting the GUI comprises:
based on the first external device being associated with the user of the electronic device, outputting a GUI for re-registration of the first external device as a device of the user.

15. The control method of claim 10,
wherein the outputting the GUI comprises:
identifying information on an access point (AP) communicatively connected with the first external device based on the received temporary registration information;
based on receiving an AP signal corresponding to the identified AP information, identifying whether the first external device is located in a space in which the electronic device is located; and
based on the first external device being located in the space in which the electronic device is located, outputting a GUI for final authentication of the user access authority for the first external device.

16. The control method of claim 10,
wherein the finally authenticating the user access authority comprises:
based on receiving the user input corresponding to the output GUI, transmitting, to the server, a fourth signal releasing a temporary registration of the first external device to the server.

17. The control method of claim 16,
wherein the finally authenticating the user access authority comprises:
based on receiving the user input corresponding to the output GUI, identifying whether the user access authority for the first external device was finally authenticated;
identifying a number of times that the user access authority for the first external device is not finally authenticated based on identifying whether the user access authority for the first external device was finally authenticated; and
based on the number of times being greater than or equal to a predetermined value, transmitting, to the server, the fourth signal releasing a temporary registration of the first external device to the server.

18. The control method of claim 10,
wherein the user account information is corresponding to a user account or an account interlocked with the user account.

19. A non-transitory computer readable recording medium storing computer instructions that cause an electronic device to perform an operation when executed by at least one processor of the electronic device, wherein the operation comprises;
obtaining temporary registration information of a first external device temporarily registered to a server;
outputting a graphical user interface (GUI) for final authentication of user access authority for the first external device based on the obtained temporary registration information;
based on a user input corresponding to the output GUI, finally authenticating the user access authority for the first external device; and
transmitting final authentication information of the first external device and user account information corresponding to the user access authority to the server,
wherein the temporary registration information is identified by a second external device based on a first signal received from the first external device, and transmitted to the server by the second external device.

20. The medium of claim 19,
wherein the obtaining the temporary registration information comprises:
obtaining the temporary registration information of the first external device registered to the server based on at least one of a second signal received from the server or a third signal received from the first external device.
